(19) United States
(12) Patent Application Publication
(10) Pub. No.: US 2023/0202024 A1
(43) Pub. Date: Jun. 29, 2023

(54) TOOL BELT STAND

(71) Applicant: Brian Sciabarrasi, Lunenburg, MA (US)

(72) Inventor: Brian Sciabarrasi, Lunenburg, MA (US)

(21) Appl. No.: 17/969,988

(22) Filed: Oct. 20, 2022

Related U.S. Application Data
(60) Provisional application No. 63/257,854, filed on Oct. 20, 2021.

(51) Int. Cl. B25H 3/00

(52) U.S. Cl. CPC B25H 3/00

(57) ABSTRACT

A tool belt stand is configured for supporting a tool belt including a main strap configured for fastening about a wearer's waist and first and second pouches. Each pouch includes a strap-attachment loop at a pouch upper end through which the main strap is situated in order to retain the pouch on the main strap. The tool belt stand includes a base for setting upon a surface; a support post extending upwardly from the base along a post axis; and first and second tool-belt support arms situated above the base and depending from the post. Each tool-belt support arm is inserted into the strap-attachment loop of one of the first and second pouches such that the first and second pouches are suspended by the first and second tool-belt arms. The tool belt stand further includes a tool-pouch stabilizer that contacts and maintains in upright orientations the first and second pouches.

### PROVISIONAL PRIORITY CLAIM

Priority based on Provisional Application Ser. No. 63/257,854 filed Oct. 20, 2021 under the title “TOOL BELT STAND” is claimed. Moreover, the entirety of the previous provisional application, including the drawings, is incorporated herein by reference as if set forth fully in the present application.

### BACKGROUND

Tool belts are ubiquitous equipment among skilled tradespersons including, for example, carpenters, electricians, plumbers, roofers, and general repair and maintenance personnel. A tool belt typically includes a flexible main strap of leather or durable synthetic material, such as nylon or polyester, with a buckle for securing around a user's waist. Attached to the main strap is one or more pouches for retaining various items. Each pouch, which can also be fabricated from leather or a synthetic material, may include/define a plurality of two or more storage sections or cavities (pockets) for storing necessary job-site items such as tools like pliers, wrenches, fastener drivers, wire crimpers/cutters/strippers, nailsets, drywall and putty knives, etc. Additionally, pockets may be used for storing expendable items needed for a job such as nails, screws, staples, insulated ring connectors, crimp connectors, etc. A pouch typically includes a strap-attachment loop of material at its upper end through which the main strap is fed in order to retain the pouch.

A major complaint among tool belt users is that, when the belts are taken off at a jobsite, there is no place to set them down while keeping them in a generally upright orientation. As such, tool belts are set down on the ground or hung in a way that does not keep them upright. This results in items such as those listed above falling out of the pockets/pouches. This is inconvenient enough in the case of larger items, such as tools, but is substantially more inconvenient in the case of small fasteners such as screws and nails, particularly when the same are separated by type and/or size in disparate pockets.

Accordingly, a need exists for a stand on which a tool belt can be supported and retained with the pouches/pockets in an upright position when not in place about a user's waist.

### SUMMARY

Alternative embodiments of a tool belt stand are preferably configured for temporarily supporting a tool belt including a main strap configured for fastening about a wearer's waist and supporting first and second pouches. Each pouch is defined by at least one pocket designed for storing necessary job-site items such as tools and fasteners. Each pouch further includes a pouch inner side that rests against and adjacent the leg of a user wearing the tool belt, a pouch outer side opposite the pouch inner side that faces away from a user wearing the tool belt, and a strap-attachment loop at a pouch upper end through which the main strap is situated in order to slidably retain (e.g., suspend) the pouch on the main strap.

Illustratively configured, a tool belt stand includes a base for setting upon a substantially horizontal surface, such as the ground outdoors or the floor of a building. Depending vertically upwardly from the base is a rigid support post that extends lengthwise along a post axis. Attached to the support post at a predefined distance above the base are first (or left) and second (or right) tool-belt support arms.

Before proceeding further in the summary and description, it is noted that directional and spatial-orienting indicators such as “below,” “above,” “downwardly,” “upwardly,” “vertically,” and “horizontally” are, unless otherwise noted, used as those terms are normally used and understood relative to the earth's gravitational field. Moreover, with specific reference to the tool belt stand, and structural elements thereof, these and similar terms are used and defined throughout the specification and claims as spatial references when the base of the tool stand is set upon a horizontal—or substantially horizontal—surface such as the ground or the floor of a building. Terms such as these all have generally understood meanings with reference to gravity, whether people are expressly conscious of this or not. While the tool belt stand can certainly be set on its side or inverted, references to “upward,” “downward,” and the like are made under the consistent assumption that the tool belt stand is oriented for use as intended.

The first and second tool-belt support arms extend substantially perpendicular to the post—and parallel to the base—and are mutually spaced apart. Illustratively embodied, the first and second tool-belt support arms are in substantially parallel spatial relation to one another. However, the first and second tool-belt support arms may be in other-than-parallel relationship to one another. For example, the first and second tool-belt support arms may mutually converge toward—and mutually diverge away from—the vertical post to which they are attached. In any event, the tool belt stand is most commonly configured such that the first and second support arms are spatially situated on opposite sides of a vertical plane that includes the post axis and passes between, and not through either of, the first and second tool-belt support arms.

Each of the first and second tool-belt support arms is configured for insertion into the strap-attachment loop—alongside the main strap—of one of the first and second tool pouches of the tool belt when the tool belt is removed from a user and set upon the tool belt stand for temporary support. More specifically, in order to hang the tool belt on the tool belt stand, a tool-belt support arm is passed through the attachment loop of each of the first and second tool pouches with the main strap of the tool belt still within each of the attachment loops as well. As those familiar with the use of tool belts know, loads within the tool pouches are frequently off balance and top heavy. This is generally not an issue when the tool belt is being worn by a user because a user's body (e.g., lap, hip, and/or upper thigh) prevents the tool pouch from tipping to a degree sufficient to allow contents to fall out of the open top of the pouch. However, once the tool belt is removed, the first and second tool pouches configured as previously described tend to tilt such that their lower ends pivot inwardly toward one another.

In order to maintain each tool pouch in a sufficiently upright orientation (i.e., an orientation that prevents content spillage) while the tool belt is supported on the tool belt stand, an included tool-pouch stabilizer depends from at least one of the base and the post, either directly or through one or more intermediate structural elements (e.g., one or both of the first and second tool-belt support arms). The tool-pouch stabilizer is configured for contactably engaging the pouch inner side of at least one of the first and second tool pouches of the tool belt when set upon the tool belt stand for temporary support.

In at least one configuration, the support post extends upwardly above the tool-belt support arms and terminates in a stand handle by which the tool belt stand can be picked up and carried by a user, with or without a tool belt supported thereon. A still-more-specific embodiment further includes at least a first tool holder forming a permanent part of the structure of the tool belt stand. For this reason, each tool holder may be referred to as a “structural tool holder,” which helps distinguish it from the tool belt. Each tool holder is configured for temporarily storing tools not stored within a tool belt placed upon the tool belt stand. For convenient access, each tool holder may be situated above the first and second tool-belt support arms and below the stand handle.

While each structural tool holder may be variously configured within the scope and contemplation of the invention as claimed, one version includes a single cylindrical side wall defining a cylindrical element having open top and bottom ends. The open ends facilitate the storage of tools with elongated portions that can extend below the tool holder. Illustrative, nonlimiting examples of such tools include drills, hammers, pry bars, screwdrivers, pliers, socket wrenches, and flashlights. It is to be understood that, while advantageous and efficient, a cylindrical shape is merely illustrative; alterative versions may be configured as rings (which can be conceptualized as short cylinders) or non-circular/non-cylindrical “tubular” structures, each of which may be defined by more than one side wall extending between the top and bottom ends. Moreover, while the inclusion of an open bottom end is advantageous for the reasons stated, a structural tool holder may have a closed bottom end in order to contain items smaller than the examples aforementioned.

In addition to the tool stand in isolation, embodiments may be claimed as “apparatus for temporary tool storage,” or similar. Such embodiments might include the a tool belt stand in combination with a tool belt supported thereby. There is more than ample written description and depiction in the drawings to support such claims.

Representative embodiments are more completely described and depicted in the following detailed description and the accompanying drawings.

### BRIEF DESCRIPTION OF THE DRAWINGS

FIG. 1 is a side view of a tool belt stand configured for temporarily supporting a tool belt;

FIG. 2 is a frontal view of a tool belt stand similar to the tool belt stand depicted in FIG. 1, differing only in its further inclusion of dual structural tool holders for holding tools such as hammers, saws, and power drills; and

FIG. 3 is a frontal view of the tool belt stand shown in FIG. 2 on which there is hung for temporary support a tool belt including a main strap and first and second pouches illustratively containing a variety of tools, as well as a drill and hammer illustratively retained by the structural tool holders.

### DETAILED DESCRIPTION

The following description of a variously configured tool belt stand is illustrative in nature and not intended to unduly limit the invention or its application of uses. Accordingly, the various implementations, aspects, versions and embodiments described in the summary and detailed description are in the nature of non-limiting examples falling within the scope of the appended claims and do not serve to restrict the maximum scope of the claims.

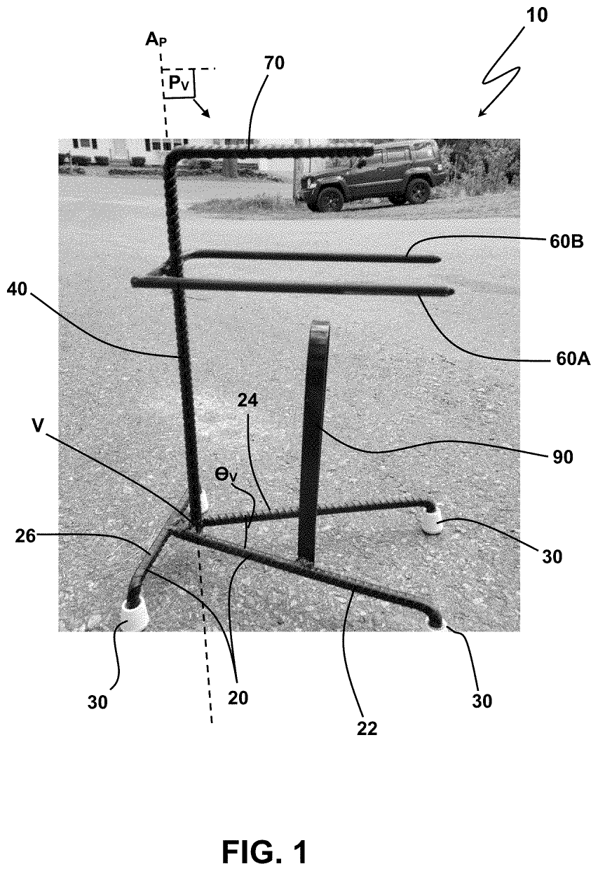

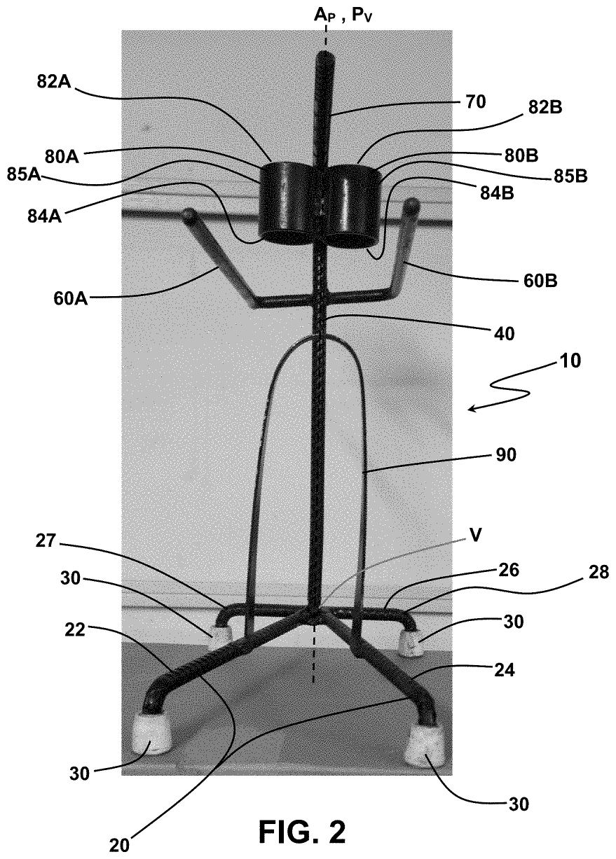

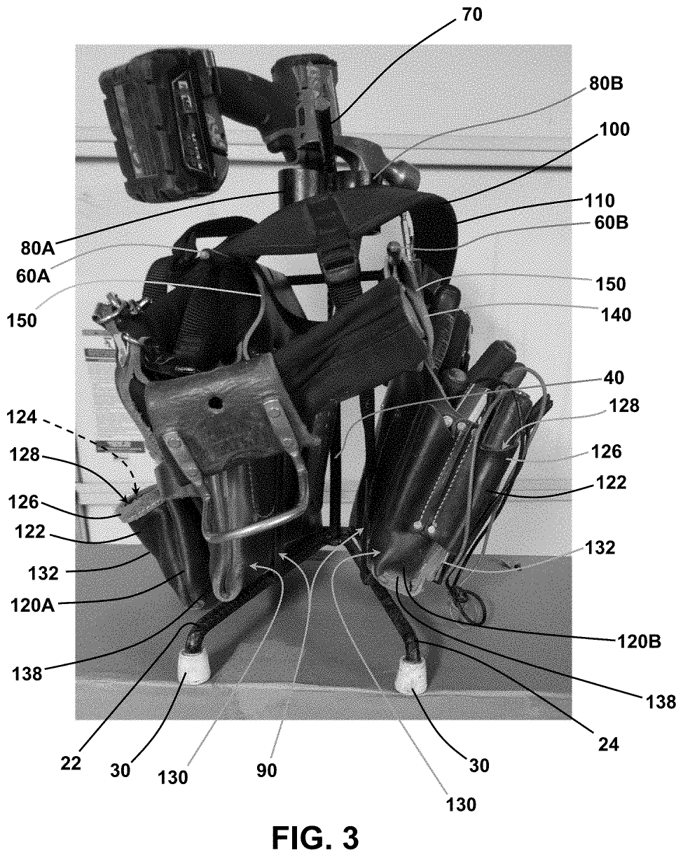

Shown in the included drawings are various views of an illustratively embodied tool belt stand generally identified by the reference number 10. A basic first embodiment is described initially with general reference to FIG. 1. An alternative, second embodiment, modified slightly relative to the first, is shown in FIGS. 2 and 3. Moreover, for the sake of efficiency and descriptive clarity, illustrative, non-limiting additions, optional features, and alternative configurations of various elements are described with conjunctive reference to the basic illustrative configuration of FIG. 1. Additionally, throughout the specification and drawings, like elements across alternative embodiments, or various views of the same embodiment, are referenced by similar or identical numeric and/or alphanumeric reference characters.

Referring initially to the side view FIG. 1, a first embodiment of a tool belt stand 10 includes a base 20 for setting upon a substantially horizontal surface. Depending vertically upwardly from the base 20 is a rigid support post 40 that extends lengthwise along a post axis A_{P}. Attached to the support post 40 at a predefined distance above the base 20 are first and second tool-belt support arms 60A and 60B. The support post 40 extends upwardly above the tool-belt support arms 60A and 60B and terminates at a stand handle 70 by which the tool belt stand 10 can be lifted and carried by a user.

A second embodiment is shown in the frontal views of FIGS. 2 and 3, the latter of which depicts a tool belt 100 suspended for temporary storage upon the tool belt stand 10. The first and second illustrative embodiments differ substantively only in that the second embodiment further includes structural first and second tool holders 80A and 80B (i.e. tool holders included as permanent structural portions of the tool belt stand 10). While the structural first and second tool holders 80A and 80B may be variously configured within the scope and contemplation of the invention as claimed, the examples of FIGS. 2 and 3 are in the form of cylindrical elements with, respectively, open top ends 82A and 82B and open bottom ends 84A and 84B. Each tool holder 80A and 80B is defined by, respectively, a side wall 85A and 85B that extends between, respectively, the open top ends 82A and 82B and open bottom ends 84A and 84B. The open bottom ends 84A and 84B facilitate the storage of tools not stored in the tool belt 100 and including elongated portions that can extend below the first and second tool holders 80A and 80B. The examples of a drill and hammer are shown in FIG. 3. In the case of the hammer, the handle of the hammer extends far below the second tool holder 80B. Furthermore, in the example depicted, the structural first and second tool holders 80A and 80B are secured to the rigid support post 40 at a location above the first and second tool-belt support arms 60A and 60B, in order to facilitate access thereto without interference to or by the support arms 60A and 60B, and below the stand handle 70 so that the stand handle 70 can be conveniently grasped.

Elements common to both illustrative embodiments are described with collective reference to FIGS. 1-3. The first and second tool-belt support arms 60A and 60B extend substantially perpendicular to the post 40—and parallel to the base 20—and are mutually spaced apart. Moreover, the first and second tool-belt support arms 60A and 60B are spatially situated on opposite sides of a vertical plane P_{V} that includes the post axis A_{P} and passes between—and not through either of—the first and second tool-belt support arms 60A and 60B. In at least one particular configuration, the first and second tool-belt support arms 60A and 60B are furthermore mutually symmetrically disposed about the vertical plane P_{V}.

Referring to FIG. 3, an illustrative tool belt 100 is shown supported by the tool belt stand 10. The tool belt 100 includes a main strap 110 configured for fastening about a wearer's waist. Supported by the main strap 110 are first and second tool pouches 120A and 120B. Each of the first and second tool pouches 120A and 120B is defined by at least one pocket 122 configured for storing tools and other job-site items (shown but not numbered). Each pocket has a pocket interior 124 and an upper pocket end 126 defining a pocket opening 128 through which job-site items are introduced into and removed from the pocket interior 124. Each of the first and second tool pouches 120A and 120B further includes a pouch inner side 130 that bears, for example, against an adjacent leg of a user wearing the tool belt 10, a pouch outer side 132 opposite the pouch inner side 130 that faces away from the wearer of the tool belt 10, a pouch lower end 138 and a pouch upper end 140 including a strap-attachment loop 150 through which the main strap 110 is situated in order to slidably retain (e.g., suspend) the tool pouches 120A and 120B on the main strap 110.

Known to those familiar with tool belts 100 such as that of FIG. 3 is that there is typically space (slack) between the strap-attachment loop 150 and the main strap 110 that enables the tool pouch 120A and/or 120B to slide readily along the main strap 110. Each of the first and second tool-belt support arms 60A and 60B is configured for insertion into the strap-attachment loop 150—alongside the main strap 110—of one of the first and second pouches 120A and 120B when the tool belt 100 is set upon the tool belt stand 10 for temporary storage. More specifically, in order to hang the tool belt 100 on the tool belt stand 10, one of the first and second tool-belt support arms 60A and 60B is fed through the strap-attachment loop 150 of each of the first and second tool pouches 120A and 120B alongside the main strap 110.

As mentioned in the summary, loads within the first and second tool pouches 120A and 120B are frequently off balance and top heavy. This can be seen in FIG. 3 in which the first and second tool pouches 120A and 120B are tilted on the tool belt stand 10 with the pouch lower ends 138 thereof pivoted inwardly toward one another relative to the pouch upper ends 140. As shown in each of FIGS. 1-3, in order to maintain each of the first and second tool pouches 120A and 120B in a sufficiently upright orientation to obviate content spillage while the tool belt 100 is supported on the tool belt stand 10, the tool belt stand 10 includes a tool-pouch stabilizer 90.

In the versions depicted, the tool-pouch stabilizer 90 depends directly and upwardly from the base 20. Moreover, while the tool-pouch stabilizer 90 could be of various alternative configurations and depend directly from the post 40 or one or both of the first and second tool-belt support arms 60A and 60B, in the versions of FIGS. 1-2 the tool-pouch stabilizer 90 is formed as a rigid (i.e., sufficiently rigid to self-supporting) and substantially parabolic band of metal secured to the base 20. Regardless of its specific shape, the tool-pouch stabilizer 90 is configured for contactably engaging the pouch inner side 130 of at least one of the first and second tool pouches 120A and 120B hung upon at least one of the first and second tool-belt support arms 60A and 60B. In the example shown in FIG. 3, the tool-pouch stabilizer 90 is situated between the first and second tool pouches 120A and 120B of the illustrative tool belt 100 and is also symmetrically disposed about the vertical plane P_{V}.

It will be appreciated that the main components of the tool belt stand 10, such as the base 20, post 40, tool-belt support arms 60A and 60B, and tool-pouch stabilizer 90, may be variously configured while remaining within the scope of the invention as defined in the appended claims. However, each of the specific, non-limiting examples depicted in FIGS. 1-3 is fabricated from rigid metal bars; more specifically, so-called “rebar,” a ubiquitous term for steel reinforcing rod used in concrete.

The base 20 includes first and second base-frame members 22 and 24 forming a V-shape and joined at a vertex V that resides along the post axis A_{P} and within the vertical plane P_{V}. The vertical plane P_{V} may be defined such that it defines a bisector evenly splitting the vertex angle Θ_{V} defined by first and second base-frame members 22 and 24. A third base-frame member 26 is joined to the first and second base-frame members 22 and 24 at the vertex V and extends perpendicularly to the vertical plane P_{V} when the vertical plane P_{V} is defined as an angular bisector as described above.

At ends of the first and second base-frame members 22 and 24 opposite the vertex V, each of the first and second base-frame members 22 and 24 terminates at a foot 30 configured to engage a generally horizontal surface (ground or floor). At each of two opposed first and second ends 27 and 28 thereof, the third base-frame member 26 terminates at a foot 30 configured to engage the horizontal surface in generally the same plane as the feet 30 of the first and second base-frame members 22 and 24. It warrants reemphasis that the particular configuration of the base 20 is not of central importance to the overall inventive concept, certainly not in its broadest sense; what is of consequence is that a stabilizing base 20 is provided, and that could be comprised of a plurality of frame members, legs, or a single plate of material, by way of non-limiting example.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A tool belt stand configured for temporarily supporting a tool belt including a main strap configured for fastening about a wearer's waist and first and second pouches, each of which pouches includes a pouch inner side that rests against and adjacent the leg of a user wearing the tool belt, a pouch outer side opposite the pouch inner side that faces away from a user wearing the tool belt, and a strap-attachment loop at a pouch upper end through which the main strap is situated in order to slidably retain the pouch on the main strap, the tool belt stand comprising:
a base configured for setting upon a substantially horizontal surface;
a rigid support post extending upwardly from the base along a post axis;
first and second tool-belt support arms situated above the base and depending from the post; and
a tool-pouch stabilizer depending from at least one of the base and the post, wherein
(i) each of the first and second tool-belt support arms extends substantially perpendicularly to the post;
(ii) the first and second tool-belt support arms are mutually spaced apart on opposite sides of a vertical plane that includes the post axis and passes between, and not through either of, the first and second tool-belt support arms;
(iii) each of the first and second tool-belt support arms is configured for insertion into the strap-attachment loop, alongside the main strap, of one of the first and second pouches of the tool belt when the tool belt is removed from a user and set upon the tool belt stand for temporary support; and
(iv) the tool-pouch stabilizer is configured for contactably engaging the pouch inner side of at least one of the first and second pouches of a tool belt set upon the tool belt stand for temporary support in order to maintain that pouch in a sufficiently upright orientation to prevent contents thereof from falling out.

2. The tool belt stand of claim 1 wherein the mutually spaced apart first and second tool-belt support arms are furthermore in substantially parallel spatial relation to one another.

3. The tool belt stand of claim 2 wherein at least one of
(a) the first and second tool-belt support arms are furthermore mutually symmetrically disposed about the vertical plane; and
(b) the tool-pouch stabilizer is symmetrically disposed about the vertical plane.

4. The tool belt stand of claim 3 wherein both
(a) the first and second tool-belt support arms are furthermore mutually symmetrically disposed about the vertical plane; and
(b) the tool-pouch stabilizer is symmetrically disposed about the vertical plane.

5. The tool belt stand of claim 1 wherein at least one of
(a) the first and second tool-belt support arms are furthermore mutually symmetrically disposed about the vertical plane; and
(b) the tool-pouch stabilizer is symmetrically disposed about the vertical plane.

6. The tool belt stand of claim 5 wherein both
(a) the first and second tool-belt support arms are furthermore mutually symmetrically disposed about the vertical plane; and
(b) the tool-pouch stabilizer is symmetrically disposed about the vertical plane.

7. The tool belt stand of claim 6 wherein the support post extends upwardly above the tool-belt support arms and terminates in a stand handle by which the tool belt stand can be picked up and carried by a user.

8. The tool belt stand of claim 7 further comprising at least a first tool holder forming a permanent part of the structure of the tool belt stand and (i) configured for temporarily storing tools not stored within a tool belt placed upon the tool belt stand and (ii) situated above the first and second tool-belt support arms and below the stand handle.

9. Apparatus for temporary storage of job-site tools comprising:
a tool belt including a main strap configured for fastening about a wearer's waist and first and second pouches, each of which pouches includes a strap-attachment loop at a pouch upper end through which the main strap is situated in order to slidably retain the pouch on the main strap; and
a tool belt stand comprising
(a) a base configured for setting upon a substantially horizontal surface;
(b) a rigid support post extending upwardly from the base along a post axis; and
(c) first and second tool-belt support arms situated above the base and depending from the post, wherein
(i) each of the first and second tool-belt support arms extends substantially perpendicularly to the post;
(ii) the first and second tool-belt support arms are mutually spaced apart on opposite sides of a vertical plane that includes the post axis and passes between and not through either of the first and second tool-belt support arms;
(iii) the first tool-belt support arm is inserted into the strap-attachment loop of the first pouch such that the first pouch is suspended by the first tool-belt arm; and
(iv) the second tool-belt support arm is inserted into the strap-attachment loop of the second pouch such that the second pouch is suspended by the first tool-belt arm.

10. The apparatus of claim 9 wherein
(a) the tool belt stand further comprises a tool-pouch stabilizer; and
(b) the tool-pouch stabilizer is in contacting engagement with at least one of the first and second pouches of the tool belt in order to maintain that pouch in a sufficiently upright orientation to prevent contents thereof from falling out.

11. The apparatus of claim 10 wherein the mutually spaced apart first and second tool-belt support arms are furthermore in substantially parallel spatial relation to one another.

12. The apparatus of claim 11 wherein at least one of
(a) the first and second tool-belt support arms are furthermore mutually symmetrically disposed about the vertical plane; and
(b) the tool-pouch stabilizer is symmetrically disposed about the vertical plane.

13. The apparatus of claim 12 wherein both
(a) the first and second tool-belt support arms are furthermore mutually symmetrically disposed about the vertical plane; and
(b) the tool-pouch stabilizer is symmetrically disposed about the vertical plane.

14. The apparatus of claim 13 wherein the support post extends upwardly above the tool-belt support arms and terminates in a stand handle by which the tool belt stand can be lifted and carried by a user.

15. The apparatus of claim 12 wherein the support post extends upwardly above the tool-belt support arms and terminates in a stand handle by which the tool belt stand can be lifted and carried by a user.

16. The apparatus of claim 9 wherein the support post extends upwardly above the tool-belt support arms and terminates in a stand handle by which the tool belt stand can be lifted and carried by a user.

17. A method of temporarily supporting a tool belt including a main strap configured for fastening about a wearer's waist and at least a first pouch, each of which at least one pouches includes a pouch inner side that rests against and adjacent the leg of a user wearing the tool belt, a pouch outer side opposite the pouch inner side that faces away from a user wearing the tool belt, and a strap-attachment loop at a pouch upper end through which the main strap is situated in order to slidably retain the pouch on the main strap, the method comprising:
(a) providing a tool belt stand that comprises
a base configured for setting upon a substantially horizontal surface;
a rigid support post extending upwardly from the base along a post axis;
first and second tool-belt support arms situated above the base and depending substantially perpendicularly from the post; and
a tool-pouch stabilizer depending from at least one of the base and the post;
(b) inserting one of the first and second tool-belt support arms into the strap-attachment loop, alongside the main strap, of the at least first pouch of the tool belt so that the first pouch is suspended from the support arm; and
(c) allowing the inner side of the first pouch to contactably engage the tool-pouch stabilizer so that the tool-pouch stabilizer maintains the first pouch in a sufficiently upright orientation to prevent contents thereof from falling out.

18. The method of claim 17 wherein the tool belt includes a second pouch retained by the main strap and the method further comprises the steps of
inserting the other of the first and second tool-belt support arms into the strap-attachment loop, alongside the main strap, of the second pouch of the tool belt so that the second pouch is suspended from the support arm; and
allowing the inner side of the second pouch to contactably engage the tool-pouch stabilizer so that the tool-pouch stabilizer maintains the second pouch in a sufficiently upright orientation to prevent contents thereof from falling out.
